(19) United States
(12) Patent Application Publication
(10) Pub. No.: US 2023/0070905 A1
(43) Pub. Date: Mar. 9, 2023

(54) SIMO POWER CONVERTER AND CONTROL METHOD THEREOF

(71) Applicant: BravoTek Electronics Co., Ltd., Zhubei City (TW)

(72) Inventors: Wen-Chia PI, New Taipei City (TW); Wei-Lun HSIEH, Zhubei City (TW); Wei-Hsin WEI, Zhubei City (TW)

(21) Appl. No.: 17/467,013

(22) Filed: Sep. 3, 2021

(51) Int. Cl. H02M 3/158; H02M 1/00; H02M 1/08

(52) U.S. Cl. CPC H02M 3/158; H02M 1/0009; H02M 1/08; H02M 1/009

(57) ABSTRACT

A SIMO power converter includes: a power stage having an inductor and a plurality of switches, the power stage generating a plurality of output voltages from an input voltage; a control circuit, the control circuit controlling the SIMO power converter to be operated at either an OPDC (Ordered Power Distributive Control) mode or a Peak Current Control (PCC) mode according with different loading conditions, the control circuit further generating a plurality of duty cycles based on an inductor current of the inductor and the plurality of output voltages; and a logic control and gate driver for generating a plurality of switch control signals based on the duty cycles from the control circuit, the plurality of switch control signals for controlling the plurality of switches of the power stage.

### TECHNICAL FIELD

The disclosure relates in general to a SIMO (Single Inductor Multiple Output) power DC (direct current)-DC converter and a control method thereof.

### BACKGROUND

Consumers expect hearables, wearables, and other ultra-small electronic devices to be long on battery life despite their tiny form factor. The device size does limit the battery capacity.

New consumer wearable, hearable and connected devices are continually getting smaller and less invasive. Engineers face increasing challenges trying to pack all the necessary product features into a tiny form factor of an earbud or a wearable gadget such as a ring, bracelet, or skin patch. These space-constrained products benefit from tiny low-power power management circuits using space-saving SIMO (single-inductor, multiple-output) technology.

A single-inductor multiple-output (SIMO) architecture provides a better solution for tiny devices requiring good thermal performance, by integrating functionality in smaller devices that would otherwise require multiple discrete components. A SIMO power converter can support multiple output stages while using only one inductor. The SIMO power converters have many advantages, such as small size, light weight and significant overall cost saving as well as good conversion efficiency. Due to these advantages, the SIMO power converter has been also used by in a power management integrated circuit (PMIC). The PMIC uses time-multiplexing peak-current control (PCC) to convert electrical energy to each output with different inductor charging and discharging cycle. It can convert larger energy pack to the outputs at a time with acceptable voltage ripple to reduce switching loss and results in good conversion efficiency; however, it can only operate at the time-multiplexing DCM control, which limits the load current to be less than 150 mA for each output. Although a SIMO power converter controlled with OPDC (Ordered Power Distributive Control) scheme can operate at both DCM and CCM to provide a larger output current capability. The DCM control with OPDC scheme cannot perform conversion efficiency as good as the time-multiplexing peak-current control. Therefore, a new SIMO power converter that can operate at both time-multiplexing PCC and OPDC control is required to perform good conversion efficiency from light to heavy load current range.

The SIMO topology is capable of generating independently controlled buck, boost, and buck-boost outputs simultaneously. A control scheme is developed for reduced cross-regulation in SIMO DC-DC converters.

Since a SIMO power converter can support multiple outputs while using only one inductor, it is an excellent candidate to minimize the component count and thus reduce the production cost. Apparently, the area of print circuit board can be reduced greatly, thereby miniaturizing devices. Minimizing the cross regulation is required in SIMO DC-DC converter design while improving the power delivery quality and the load driving capability are also important. For example, due to the demand increased power efficiency in power management ICs, SIMO power converter as the key device should be also operated under various load conditions, such as continuous current mode (CCM) in heavy load condition, discontinuous current mode (DCM) in medium load condition, pulse skipping mode (PSM) and time-multiplexing PCC in light load or no-load condition. To achieve these goals, a SIMO architecture with novel control scheme is still demanding.

### SUMMARY

According to one embodiment of the application, provided is SIMO (Single Inductor Multiple Output) power converter including: a power stage having an inductor and a plurality of switches coupled to the inductor, the power stage generating a plurality of output voltages from an input voltage; a control circuit coupled to the power stage, the control circuit controlling the SIMO power converter to be operated at either an OPDC (Ordered Power Distributive Control) mode or a Peak Current Control (PCC) mode according with different loading conditions, the control circuit further generating a plurality of duty cycles based on an inductor current of the inductor and the plurality of output voltages; and a logic control and gate driver, coupled to the control circuit and the power stage, the logic control and gate driver generating a plurality of switch control signals based on the duty cycles from the control circuit, the plurality of switch control signals for controlling the plurality of switches of the power stage.

According to another embodiment, provided is a control method for a SIMO (Single Inductor Multiple Output) power converter generating a plurality of output voltages from an input voltage, the control method including: controlling the SIMO power converter to be operated at either an OPDC (Ordered Power Distributive Control) mode or a Peak Current Control (PCC) mode according with different loading conditions; generating a plurality of duty cycles based on an inductor current of an inductor and the plurality of output voltages; and generating a plurality of switch control signals based on the duty cycles, the plurality of switch control signals for controlling a plurality of switches of the SIMO power converter.

### BRIEF DESCRIPTION OF THE DRAWINGS

FIG. 1 shows a circuit diagram of a SIMO (Single Inductor Multiple Output) power converter according to one embodiment of the application.

FIG. 2 shows a circuit diagram of the energy generating circuit according to one example of the application.

FIG. 3 shows a circuit diagram of the energy distributing circuit according to one example of the application.

FIG. 4A shows imperfect balance and FIG. 4B shows perfect balance in one embodiment of the application.

FIG. 5 shows DCM OPDC with three Channels in PSM according to one embodiment of the application.

FIG. 6 shows inductor peak current in one embodiment of the application.

FIG. 7 shows signal diagram of the SIMO power converter 100 in one embodiment of the application.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DESCRIPTION OF THE EMBODIMENT

Technical terms of the disclosure are based on general definition in the technical field of the disclosure. If the disclosure describes or explains one or some terms, definitions of the terms are based on the description or explanation of the disclosure. Each of the disclosed embodiments has one or more technical features. In possible implementation, one skilled person in the field could selectively implement part or all technical features of any embodiment of the disclosure or selectively combine part or all technical features of the embodiments of the disclosure.

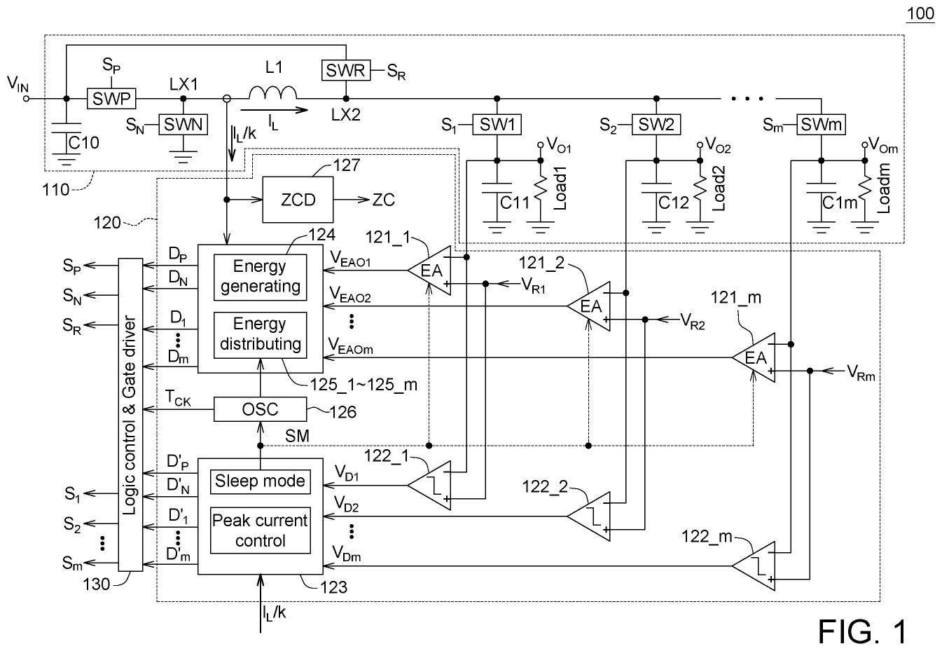

FIG. 1 shows a circuit diagram of a SIMO (Single Inductor Multiple Output) power converter according to one embodiment of the application. As shown in FIG. 1, the SIMO power converter 100 according to one embodiment of the application includes a power stage 110, a control circuit 120 and a logic control and gate driver 130. The power stage 110 of the SIMO power converter 100 generates a plurality of output voltages V_{O1}, V_{O2}, . . . , V_{Om} (m being a positive integer) from an input voltage V_{IN}. In the following, the SIMO power converter 100 has a plurality of channels; and a channel is defined as a signal path for generating an output voltage among the plurality of output voltages V_{O1}, V_{O2}, . . . , V_{Om}. The plurality of output voltages V_{O1}, V_{O2}, . . . , V_{Om} may be also referred as channel output voltages.

The power stage 110 includes an inductor L1, a plurality of switches SWP, SWN, SWR, SW1, SW2, . . . , SWm, a plurality of capacitors C10, C11, C12, . . . C1m, and a plurality of loads Load1, Load2 . . . , Loadm. The switches SWP, SWN, SWR are also referred as input switches while the switches SW1, SW2, . . . , SWm are also referred as output switches.

The inductor L1 is coupled between a first node LX1 and a second node LX2. An inductor current I_{L} flows through the inductor L1. The inductor L1 is coupled to the switches SWP, SWN, SWR, SW1, SW2, . . . , SWm.

The switch SWP is coupled between the input voltage VIN and the first node LX1. The switch SWN is coupled between a ground terminal GND and the first node LX1. The switch SWR is coupled between the input voltage VIN and the second node LX2. The switch SW1 is coupled between the second node LX2 and the first output voltage V_{O1}. The switch SW2 is coupled between the second node LX2 and the second output voltage V_{O2}. The switch SWm is coupled between the second node LX2 and the m-th output voltage V_{Om}.

The capacitor C10 is coupled between the input voltage V_{IN} and the ground terminal GND. The plurality of capacitors C11, C12, . . . C1m, and the plurality of loads Load1, Load2 . . . , Loadm are coupled in parallel between the output voltages V_{O1}, V_{O2}, . . . V_{Om} and the ground terminal GND, respectively. Still further, the power stage 110 has a current sense circuit which senses a current I_{L}/k (k being a positive number) to the control circuit 120. The current I_{L}/k is 1/k of the inductor current I_{L}.

The control circuit 120 is coupled to the power stage 110. The control circuit 120 includes a plurality of error amplifiers (EA) 121_1˜121_m, a plurality of comparators 122_1˜122_m, a control unit 123, an energy generating circuit 124, a plurality of energy distributing circuits 125_1˜125_m, an oscillator 126 and a zero current detector (ZCD) 127. The current I_{L}/k from the power stage 110 is fed into the energy generating circuit 124 for energy generating and energy distributing calculation. Also, the current I_{L}/k from the power stage 110 is fed into the control unit 123 for peak current control. Also, the current I_{L}/k from the power stage 110 is fed into the zero current detector 127 for zero current detection.

The plurality of error amplifiers 121_1˜121_m generate a plurality of error amplifier output voltages V_{EAO1}˜V_{EAOm} based on the output voltages V_{O1}, V_{O2}, . . . V_{Om} and a plurality of reference voltages V_{R1}, V_{R2}, . . . , V_{Rm}, respectively. The error amplifier output voltages V_{EAO1}˜V_{EAOm} are input into the energy generating circuit 124 and the plurality of energy distributing circuits 125_1˜125_m.

The plurality of comparators 122_1˜122_m generate a plurality of comparator output voltages V_{D1}˜V_{Dm} based on the output voltages V_{O1}, V_{O2}, . . . V_{Om} and the plurality of reference voltages V_{R1}, V_{R2}, . . . , V_{Rm}, respectively. The comparator output voltages V_{D1}˜V_{Dm} are input into the control unit 123.

The control unit 123 is coupled to the plurality of comparators 122_1˜122_m for receiving comparator output voltages V_{D1}˜V_{Dm} to perform sleep mode control function and peak current control (PCC) function. In the sleep mode control function, the control unit 123 generates a sleep mode control signal SM to the plurality of error amplifiers (EA) 121_1˜121_m and the oscillator 126; and in response to the sleep mode control signal SM from the control unit 123, the plurality of error amplifiers (EA) 121_1˜121_m and the oscillator 126 enter a sleep mode for reducing power consumption. In the peak current control function, the control unit 123 generates a plurality of duty cycles D′_{P}, D′_{N}, D′₁, D′₂, . . . , D′ₘ based on the comparator output voltages V_{D1}˜V_{Dm}. For example but not limited by, in one example, the comparator output voltages V_{D1}˜V_{Dm} determines which output voltage(s) V_{O1}, V_{O2}, . . . V_{Om} need(s) more energy; and on-time period of the duty cycles D′_{P}, D′_{N}, D′₁, D′₂, . . . , D′ₘ from the control unit 123 may be a fixed value or determined based on the input voltage V_{IN}, the output voltages V_{O1}, V_{O2}, . . . V_{Om}, the inductance of the inductor L1 and the capacitance of the output capacitors C₁₁, C₁₂, . . . , C₁ₘ. Still further, in another example, generation of the duty cycles OP, D′_{N}, D′₁, D′₂, . . . , D′ₘ may be determined based on a peak inductor current on the inductor L1, wherein the peak inductor current may be a fixed value or determined based on the input voltage V_{IN}, the output voltages V_{O1}, V_{O2}, . . . V_{Om}, the inductance of the inductor L1 and the capacitance of the output capacitors C₁₁, C₁₂, . . . , C₁ₘ.

The energy generating circuit 124 is coupled to the plurality of error amplifiers 121_1˜121_m. The energy generating circuit 124 generates a charging duty cycle D_{P} based on the plurality of error amplifier output voltages V_{EAO1}˜V_{EAOm}, wherein during the on period of the charging duty cycle D_{P}, the inductor L1 is charged by the input voltage V_{IN}. Further, the energy generating circuit 124 generates a discharging duty cycle D_{N} based on the charging duty cycle D_{P}, wherein during the on period of the discharging duty cycle D_{N}, the inductor L1 is discharged. The charging duty cycle D_{P} and the discharging duty cycle D_{N} are complementary. For example but not limited by, sum of the charging duty cycle D_{P} and the discharging duty cycle D_{N} are equal to a clock cycle T_{CK} (T_{CK}=D_{P}+D_{N}) wherein the clock cycle T_{CK} is a clock cycle of a clock signal generated by the oscillator 126.

The plurality of energy distributing circuits 125_1˜125_m are coupled to the plurality of error amplifiers 121_1˜121_m. The plurality of energy distributing circuits 125_1˜125_m generate a plurality of duty cycles D₁˜Dₘ (i.e. the first duty cycle D1 to the m-th duty cycle Dₘ) based on the plurality of error amplifier output voltages V_{EAO1}˜V_{EAOm} of the plurality of error amplifiers 121_1˜121_m.

In the following, the duty cycles D_{P}, D_{N}, D₁˜Dₘ are also referred as the charging duty cycle D_{P}, the discharge duty cycle D_{N}, the first duty cycle to the m-th duty cycle D₁˜Dₘ of a first group; and the duty cycles D′_{P}, D′_{N}, D′₁˜D′ₘ are also referred as the charging duty cycle D_{P}, the discharge duty cycle D′_{N}, the first duty cycle to the m-th duty cycle D′₁˜D′ₘ of a second group.

The oscillator 126 generates the clock signal T_{CK} to the energy generating circuit 124 and the logic control and gate driver 130.

The zero current detector 127 is coupled to the inductor L1 to detect the inductor current I_{L}. When the zero current detector 127 detects that the inductor current I_{L} reaches zero current, the zero current detector 127 outputs a zero current signal ZC.

The logic control and gate driver 130 is coupled to the power stage 110 and the control circuit 120. The logic control and gate driver 130 generates a plurality of switch control signals S_{P}, S_{N}, S_{R}, S₁, S₂, . . . , Sₘ based on the duty cycles D_{P}, D_{N}, D₁˜Dₘ, D′_{P}, D′_{N}, D′₁˜D′ₘ. The switch control signals S_{P}, S_{N}, S_{R}, S₁, S₂, . . . , Sₘ are used to control the switches SWP, SWN, SWR, SW1, SW2, . . . , SWm, respectively.

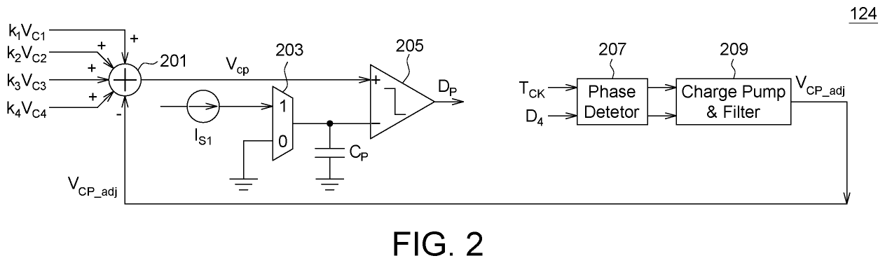

FIG. 2 shows a circuit diagram of the energy generating circuit according to one example of the application. As shown in FIG. 2, the energy generating circuit 124 according to one example of the application includes an adder 201, a multiplexer 203, a comparator 205, a phase detector 207, a charge pump and filter 209 and a capacitor C_{P}. For simplicity, in the following, m=4 is taken as an example, but the application is not limited by this.

The adder 201 adds a plurality of voltages V_{C1}, V_{C2}, V_{C3} and V_{C4} and an adjustment voltage V_{CP_adj} to generate a control voltage V_{CP}. For example but not limited by, V_{CP}=k₁*V_{C1}+k₂*V_{C2}+k₃*V_{C3}+k₄*V_{C4}−V_{CP_adj}, wherein k₁, k₂, . . . k₄ are all positive values. The voltages V_{C1}, V_{C2}, V_{C3} and V_{C4} are generated by the energy distributing circuits 125_1˜125_4, respectively. Still further, the voltages V_{C1}, V_{C2}, V_{C3} and V_{C4} are corresponding to the plurality of error amplifier output voltages V_{EAO1}˜V_{EAO4}.

The multiplexer 203 is controlled by the switch control signal S_{P}. When the switch control signal S_{P} is 0, the multiplexer 203 outputs 0V (GND); and when the switch control signal S_{P} is 1, the multiplexer 203 outputs the control current I_{S1}.

The comparator 205 compares the control voltage V_{CP} with the voltage of the capacitor C_{P} to generate the duty cycle D_{P}.

The phase detector 207 detects phases of the clock signal T_{CK} and the last duty cycle D₄ (i.e. the last duty cycle Dₘ). The charge pump and filter 209 generates the adjustment voltage V_{CP_adj} based on the output of the phase detector 207.

The capacitor C_{P} is coupled between the output of the multiplexer 203 and the ground terminal GND. The capacitor C_{P} is charged by the output of the multiplexer 203 (or said the capacitor C_{P} is charged by the control current Isi).

By the circuit configuration in FIG. 2, the energy generating circuit 124 generates the duty cycle D_{P} and the adjustment voltage V_{CP_adj}.

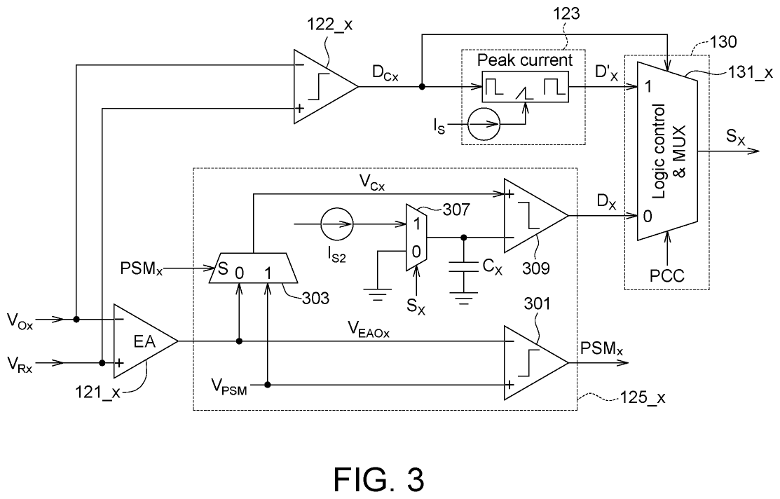

FIG. 3 shows a circuit diagram of the energy distributing circuit according to one example of the application. The energy distributing circuit 125_x (x=1˜m) according to one example of the application includes a comparator 301, a multiplexer 303, a multiplexer 307, a capacitor C_{X} and a comparator 309.

The comparator 301 compares the error amplifier output voltage V_{EAOx} of the error amplifier 121_x with a reference voltage V_{PSM} to generate a pulse-skip mode (PSM) signal PSMx. For example but not limited by, the PSM signal PSMx is logic 0 when the error amplifier output voltage V_{EAOx} of the error amplifier 121_x is higher than the reference voltage V_{PSM}, and vice versa. When the PSM signal PSMx is logic 1, the corresponding channel enters the PSM mode; and when the PSM signal PSMx is logic 0, the corresponding channel is at the EA mode. When the EA output of a channel is lower than the reference voltage V_{PSM}, this channel does not need energy for the next clock cycle and thus this channel enters the PSM mode.

The multiplexer 303 is controlled by the PSM signal PSMx from the comparator 301. The multiplexer 303 outputs among the error amplifier output voltage V_{EAOx} of the error amplifier 121_x and the reference voltage V_{PSM} as the (control) voltage V_{CX}. For example but not limited by, when the PSM signal PSMx is logic 0, the multiplexer 303 outputs the error amplifier output voltage V_{EAOx} of the error amplifier 121_x as the voltage V_{CX}; and when the PSM signal PSMx is logic 1, the multiplexer 303 outputs the reference voltage V_{PSM} as the voltage V_{CX}. The voltage V_{CX} indicates energy required by the channel.

The multiplexer 307 is controlled by the switch control signal S_{X}. The multiplexer 307 outputs among the control current I_{S2} or GND. For example but not limited by, when the switch control signal S_{X} is logic 1, the multiplexer 307 outputs the control current I_{S2}; and when the switch control signal S_{X} is logic 0, the multiplexer 307 outputs GND (0V). The output of the multiplexer 307 charges the capacitor C_{X}.

The comparator 309 compares the voltage V_{CX} with the voltage of the capacitor C_{X} to generate the duty cycle D_{X}. For example but not limited by, when the voltage V_{CX} is higher than the voltage of the capacitor C_{X}, the duty cycle D_{X} is logic 1 (i.e. ON); and when the voltage V_{CX} is lower than the voltage of the capacitor C_{X}, the duty cycle D_{X} is logic 0.

The capacitor C_{X} is coupled between the output of the multiplexer 307 and the ground terminal GND. The capacitor C_{X} is charged by the output of the multiplexer 307.

Still further, as shown in FIG. 3, the output D_{cx} of the comparator 122_x is also input into the control unit 123 and the multiplexer 131_x of the logic control and gate driver 130. Based on the output D_{cx} of the comparator 122_x and the control current Is, the control unit 123 performs peak current control function to generate the duty cycle D′ₓ.

The multiplexer 131_x of the logic control and gate driver 130 is controlled by the PCC signal PCC to select among the duty cycle Dₓ or the duty cycle D′ₓ as the switch control signal Sₓ wherein the logic control and gate driver 130 includes a plurality of multiplexer 131_1˜131_m (not shows). For example but not limited by, when the PCC signal PCC is logic 0, the multiplexer 131_x selects the duty cycle Dₓ as the switch control signal Sₓ; and when the PCC signal PCC is logic 1, the multiplexer 131_x selects the duty cycle D′ₓ as the switch control signal Sₓ.

In one embodiment of the application, the control unit 123 also performs peak current control function to generate the duty cycles D′_{P} and D′_{N}, and details are omitted here.

In one embodiment of the application, when all channels enter the PSM mode (that is, when the signals PSM₁˜PSMₘ are all logic 1), the PCC signal PCC is logic 1 which indicates that the SIMO power converter 100 enters the PCC and PSM mode, otherwise, the PCC signal PCC is logic 0 which indicates that the SIMO power converter 100 is at the OPDC and EA mode.

When the PCC signal PCC is logic 0, the switch control signal S_{X} depends on the voltage V_{CX} (i.e. the ON-time of the switch SW_{X} depends on the voltage V_{CX}); and when the PCC signal PCC is logic 1, the switch control signal S_{X} depends on the peak current control logic (i.e. the ON-time of the switch SW_{X} depends on the peak current control logic, or said the ON-time of the switch SW_{X} is controlled by the peak current control logic). In one embodiment of the application, the energy distribution circuits 125_1˜125_m have PSM and PCC (peak current control) functions.

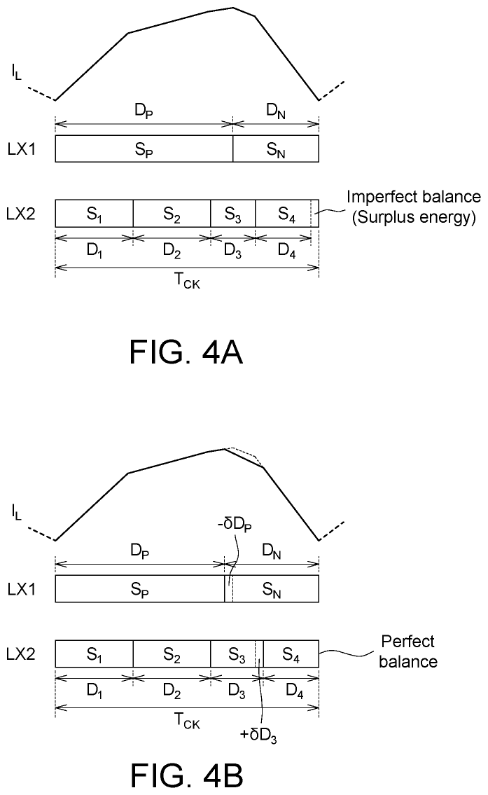

FIG. 4A shows imperfect balance and FIG. 4B shows perfect balance in one embodiment of the application. As shown in FIG. 4A, during the duty cycle D_{P}, the inductor L1 is charged; and during the duty cycle D_{N}, the inductor L1 is discharged. Further, during the duty cycle D₁, the switch SW1 is turned on to generate the output voltage V_{O1}; during the duty cycle D₂, the switch SW2 is turned on to generate the output voltage V_{O2}; during the duty cycle D₃, the switch SW3 is turned on to generate the output voltage V_{O3}; and during the duty cycle D₄, the switch SW4 is turned on to generate the output voltage V_{O4}. However, in FIG. 4A, after end of the duty cycle D₄, there is still surplus energy remained in the inductor L1. Thus, FIG. 4A shows imperfect balance between the input energy and the output energy.

To remove the surplus energy in the inductor L1 to the last output V_{Om} (i.e. V_{O4}), the duty cycle D_{P} is fined tuned to be smaller. After fine tune of the duty cycle D_{P}, perfect balance between the input energy and the output energy is achieved, as shown in FIG. 4B. How to tune the duty cycle D_{P} to achieve perfect balance is described as follows.

FIG. 4A and FIG. 4B also show OPDC (Ordered Power Distributive Control) control scheme at Continuous-Current-Mode (CCM) mode. The oscillator 126 outputs a clock signal with period T_{CK}. In the OPDC mode, at least one channel needs energy for every clock cycle continuously. The control circuit 120 is configured to control timing and charging current of the inductor L1 through activating one of the input switches SWP, SWN and discharging of the inductor L1 through activating one of the output switches SW1˜SWm sequentially.

In Continuous-Current-Mode (CCM) OPDC, the SIMO power converter 100 is operated at the OPDC mode with that the inductor current I_{L} is not discharged to zero value. In Discontinuous-Current-Mode (DCM) OPDC, the SIMO power converter 100 is operated at OPDC with that the inductor current I_{L} is discharged to zero value. Still further, in CCM OPDC with Pulse-Skip-Mode (PSM), the SIMO power converter 100 is operated at CCM OPDC with one or more channels do not need energy for every clock cycle. In DCM OPDC with PSM, the SIMO power converter 100 is operated at DCM OPDC with one or more channels do not need energy for every clock cycle.

Now how to achieve perfect balance between the input energy and the output energy by tuning the duty cycle D_{P} in one embodiment of the application is described.

Energy E_{OX} delivered to the output voltage V_{OX} in the corresponding energy distributing duty cycle D_{X} through the switch SW_{X} is expressed as following equation (1):

E_{Ox}=∫₀^{D}^{ₓ}^{T}I_{L}V_{OP}·dt (1)

In the equation (1), I_{L} refers to the inductor current and the clock period is noted by T=T_{CK}, wherein x=1, 2, . . . , m. The following description takes m=4 for the following discussions.

In the energy distributing circuit 125_1˜125_m, the corresponding capacitor C_{X} is charged by I_{S2}=V_{OX}*I_{L}/k with the duty cycle D_{X}. The amount of charge delivered to the capacitor C_{X} in the time duration is calculated as the equation (2):

Q_{Ox}=∫₀^{D}^{ₓ}^{T}I_{S}·dt=∫₀^{D}^{ₓ}^{T}I_{L}/k·dt=CₓV_{Cx} (2)

In the equation (2), V_{CX} is the output voltage of the error amplifier 121_x (when the channel does not enter PSM).

The equations (1) and (2) are combined into the equation (3):

Eₒₓ=k×Cₓ×V_{cx} (3)

The energy Eox depends on the corresponding error amplifier output.

Total energy delivered to the output loads V_{O1}˜V_{Om} are expressed equation (5):

E_{OT}=Σₓ₌₁^{m}∫₀^{D}^{ₓ}^{T}I_{L}V_{Ox}·dt

E_{OT}=kΣₓ₌₁^{m}CₓV_{Cx} (5)

In the energy generation circuit 124, the corresponding capacitor C_{P} is charged by the current I_{S1}, wherein I_{S1}=V_{IN}*I_{L}/k with the duty cycle D_{P}. The total energy transferred from the input voltage V_{IN} is expressed as the following equation (6):

E_{IT}=∫₀^{D}^{_{P}}^{T}I_{L}V_{IN}·dt=kC_{P}V_{CP} (6)

In steady state, E_{OT}=E_{IT}, then the following equation (7) is got:

$${V}_{CP} = {\sum }_{x = 1}^{4} k \frac{{C}_{x}}{{C}_{P}} {V}_{Cx} = {\sum }_{x = 1}^{4} {k}_{x} {V}_{Cx} = {k}_{1} {V}_{C 1} + {k}_{2} {V}_{C 2} + {k}_{3} {V}_{C 3} + {k}_{4} {V}_{C 4} \qquad ( 7 )$$

In the equation (7), k₁, k₂, . . . , k₄ are all positive values.

In real circuits, the total energy transferred from the input voltage V_{IN} by controlling the switch S_{P} with the duty cycle D_{P} is hard to be exactly equal to the total energy delivered to all the loads by controlling the switch S_{X} with the duty cycle D_{X} even the equation (7) is used to decide the duty cycle D_{P} due to circuit nonideality and transient response.

Therefore, the duty cycle of the last switch S₄ (m=4) will be decided by the equation (8) which means all the remained energy is delivered to the last output V_{O4}.

S₄=T_{CK}−(D₁+D₂+D₃) (8)

To solve this issue, the control voltage V_{CP} is modified as the equation (9):

V_{CP}=Σᵢ₌₁⁴kᵢ·V_{Ci}−V_{CP_adj} (9)

The energy generating circuit 124 generating the adjustment voltage V_{CP_adj} is designed as:

(1) If T_{CK}>D₁+D₂+D₃+D₄, then the adjustment voltage V_{CP_adj} is adjusted a little larger to make the control voltage V_{CP} smaller. Thus, the duty cycle D_{P} is smaller.

(2) If T_{CK}<D₁+D₂+D₃+D₄, then the adjustment voltage V_{CP_adj} is adjusted a little smaller to make the control voltage V_{CP} larger. Thus, the duty cycle D_{P} is larger.

(3) If T_{CK}=D₁+D₂+D₃+D₄, then the control voltage V_{CP} is kept at the same value. Thus, the perfect balance is achieved.

Thus, in one embodiment of the application, by fine tuning the duty cycle D_{P}, perfect balance between the input energy and the output energy is achieved and there is theoretically no cross regulation.

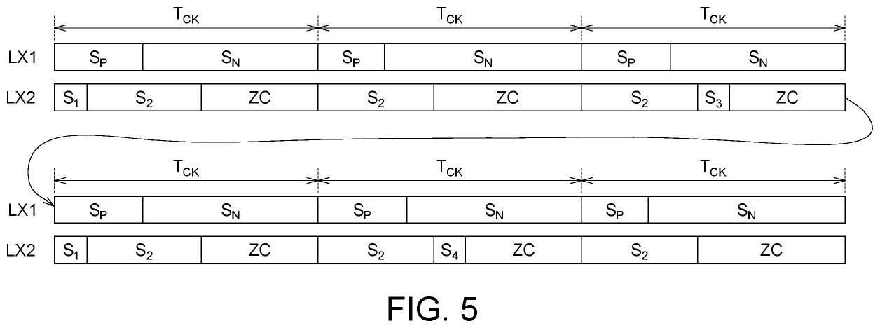

FIG. 5 shows DCM OPDC with three channels in PSM according to one embodiment of the application. As shown in FIG. 5, in the first clock cycle, the channels V_{O1} and V_{O2} need energy; in the second clock cycle, only the channel V_{O2} needs energy, and so on. Thus, in one embodiment of the application, in OPDC with PSM, the duty cycle D₂ (S₂) is decided by the corresponding error amplifier output V_{C2}; and the duty cycles D₁, D₃ and D₄ (S₁, S₃ and S₄) are all in minimum energy control. For periods those only the output voltage (or the output channel) V_{O2} requires energy (for example, in the second clock cycle and in sixth clock cycle), the duty cycle D_{P} (S_{P}) generates energy only for the output voltage (or the output channel) V_{O2}. For periods those the output voltages (or the output channels) V_{O1}, V_{O3} or V_{O4} also need energy, the duty cycle D_{P} (S_{P}) generates energy for the output voltages (or the output channels) V_{O2} and V_{O1}, V_{O3} or V_{O4}. For example, in the first clock cycle, V_{O1} also needs energy, the duty cycle D_{P} (S_{P}) generates energy for the output voltages (or the output channels) V_{O2} and V_{O1}. Thus, in the application, the duty cycles D_{P} and D′_{P} are also referred as the energy generation duty cycles; and the duty cycles D₁˜Dₘ and D′₁˜D′ₘ are also referred as the energy distribution duty cycles.

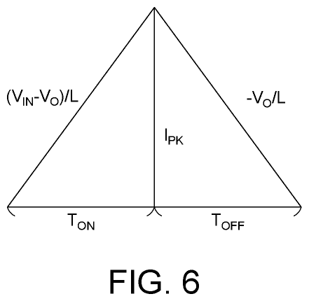

In one embodiment of the application, the ripple voltage of the output voltage may be controlled as a specified value. FIG. 6 shows inductor peak current in one embodiment of the application. Assume that output ripple voltage V_{O_ripple}=ΔV_{O}, then charge stored in the corresponding capacitor is presented as the following equation (10):

$$Δ Q = {C}_{O} Δ {V}_{O} = \frac{1}{2} {I}_{PK} ( {T}_{ON} + {T}_{OFF} ) = \frac{1}{2} {I}_{PK}^{2} L \frac{{V}_{I}}{{V}_{O} ( {V}_{I} - {V}_{O} )} \qquad ( 10 )$$

Thus, the inductor peak current I_{PK} is expressed in the following equation (11):

$${I}_{PK} = \sqrt{\frac{2 {C}_{O}}{L} \times \frac{{V}_{O} ( {V}_{I} - {V}_{O} )}{{V}_{I}} \times Δ {V}_{O}} \qquad ( 11 )$$

Thus, in one embodiment of the application, when the on time is controlled by inductor peak current I_{PK} as (11), the output ripple voltage may be also controlled as a specified value for all channels. In one embodiment of the application, all channels have the same output ripple voltage although the channels may have different output voltages.

In one embodiment of the application, the control unit 123 of the control circuit 120 of the SIMO power converter 100 has peak current control mode and sleep mode.

If a channel does not need energy for every clock cycle (i.e. when the EA output of the channel is lower than the reference voltage V_{PSM}), then this channel enters PSM mode, under control of the control circuit 120. If all channels enter PSM mode, the SIMO power converter 100 enters Peak Current Control (PCC), under control of the control circuit 120.

The energy generating period in PCC mode is decided by the inductor current I_{L} achieving to a specified peak current value or a constant time period. If the specified peak current value is calculated as the equation (11), the output voltage ripple can be controlled as constant value for different input and output voltages.

In PCC, when no channel needs energy and the inductor current I_{L} is discharged to zero, the SIMO power converter 100 enters the sleep mode. In the sleep mode, the OSC 126 and the EAs 121_1˜121_m are all turned off to reduce quiescent current. In the sleep mode, if any channel needs energy, the OSC 126 is enabled, and the SIMO power converter 100 goes back to the PCC mode.

When the SIMO power converter 100 is in PCC, if any channel needs energy continuously for N clock cycles (N being larger or equal to 2 and N being a positive integer), then the SIMO power converter 100 goes back to the OPDC mode.

In one embodiment of the application, the SIMO power converter 100 has OPDC with mixed EA mode and PSM mode.

EA Mode while PSM=0

In the EA mode, the channel requires energy for every clock cycle. The duty cycles (i.e. D₁˜Dₘ) of energy distributing are decided by V_{CX}=V_{EAOx}. If the error amplifier output voltage V_{EAOx} goes lower than the reference V_{PSM}, this channel enters the PSM mode as the PSM signal PSMx goes high.

Peak Current Control (PCC) Mode

When all channels enter PSM, the SIMO power converter 100 enters Peak Current Control (PCC) mode, under control of the control circuit 120. For a SIMO power converter in the PCC mode, when any channel needs energy continuously more than N clock cycles (N is a positive integer, for example but not limited by, N≥2), the SIMO power converter goes back to OPDC mode; and on the other hand, for the SIMO power converter in the PCC mode, when no channel needs energy continuously more than N clock cycles, the channel keeps in the PCC mode.

For the SIMO power converter in the PCC mode, energy transferring of each channel is triggered by D_{CX} which is a comparator output by comparing the output voltage V_{OX} and the corresponding reference voltage V_{Rx} of this channel. D_{CX}=1 means the channel X requiring energy; and D_{CX}=0 means the channel X having enough energy.

While the SIMO power converter 100 is still in OPDC, the duty cycles of energy distributing are decided by V_{CX}=V_{PSM}. If the SIMO power converter 100 is in PCC, the on-time of energy generating duty cycle (i.e. D_{P}) is decided by a constant time period. This constant time period is defined as a time period that the inductor current achieving a specified peak current value or others.

If the on-time of the duty cycle or the peak current value is larger, then the output voltage has larger ripple and the output switches have lower switching frequency, which result lower switching loss.

For the SIMO power converter in the PCC mode, the error amplifiers of all channels are turned off due to all channels are controlled by the comparators instead of by the error amplifiers. In this case, the error amplifiers (EAs) will be turned on again while all channels are going back to EA Mode.

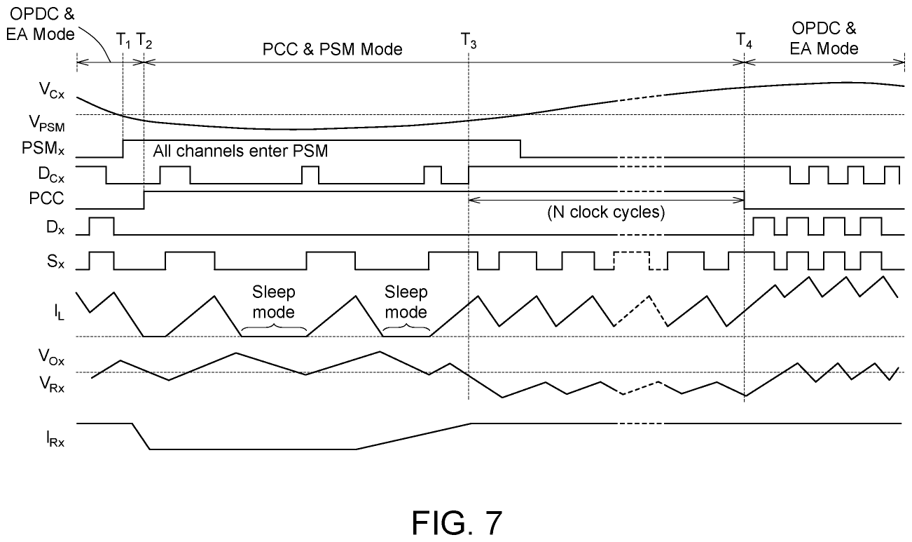

FIG. 7 shows signal diagram of the SIMO power converter 100 in one embodiment of the application. As shown in FIG. 7, before the timing T1, the SIMO power converter 100 is at OPDC and EA mode. At the timing T1, the output voltage V_{Cx} (i.e. V_{EAOx}) of the error amplifier 121_x is lower than the reference voltage V_{PSM}, then the PSMx signal of this channel goes logic high. Also, it is judged that whether all channels enter the PSM mode (i.e. it is judged whether all PSMx signals of all channels go logic high). If all channels enter the PSM mode, then the SIMO power converter 100 enters the PCC and PSM mode at the timing T2. When the SIMO power converter 100 is operated in the PCC and PSM mode, if no channel needs energy and the inductor current is discharged to zero, the SIMO enters the sleep mode. In the sleep mode, the control unit 123 of the control circuit 120 outputs the sleep mode control signal SM to the oscillator 126 and the EAs 121_1˜121_m to turn off the oscillator 126 and the EAs 121_1˜121_m.

During the timing T3, the inductor current I_{L} keeps above the zero current (i.e. during the timing T3, the ZC signal keeps low) for continuously more than (or equal than) N clock cycles. Thus, it is determined that at least one of the channels needs energy continuously more than (or equal than) N clock cycles and thus the channel(s) goes back to the EA mode to turn on the corresponding EA 121_x of this channel.

At the timing T4, the SIMO power converter 100 goes back to the OPDC and EA mode to provide the required energy to the channel(s) in the EA mode. I_{RX} refers to the load current on the load Loadx.

In one embodiment of the application, the SIMO DC-DC converter combines OPDC and PCC control. Also, the energy generating period (duty cycle D_{P}) under PCC control mode is decided by a specified inductor peak current or a constant time period. Also, when the energy distributing circuit operates at the EA mode, the energy distributing duty cycles D₁˜Dₘ under the EA mode is decided by the EA output and the sensed inductor current of the corresponding channel; and when the EA output of a channel is lower than a predetermined voltage level (V_{PSM}), this channel does not need energy for the next clock cycle and thus enters a PSM mode.

For a channel in the PSM mode, energy distributing of this channel is triggered by a comparator output of the comparator 301, which compares EA output with the predetermined voltage level (V_{PSM}).

In case of the comparator (301) comparing the EA voltage output and reference voltage of this channel, the EA may be turned off at the PSM mode.

In the PCC mode, if any channel requires energy continuously for N clock cycle where for example but not limited by, N is ≥2, the SIMO power converter goes back to the OPDC mode.

If there is at least one channel operated at EA mode, the SIMO operates at the OPDC; and the energy generating duty (D_{P}) is in response of a sum of all control voltages (V_{C1}˜V_{Cm}) (as shown in FIG. 2). The control voltage is the corresponding error amplifier output (V_{EAOx}) at the EA mode and the control voltage is the predetermined voltage (V_{PSM}) at the PSM mode.

When all channels operate at the PSM mode (all PSMx are 1) or there are a predetermined successive cycles of zero inductor current signal (zero current signal from the ZCD 127) detected, the SIMO power converter enters the PCC mode. In PCC mode, if no channel needs energy and the inductor current discharged to zero, the SIMO enters the sleep mode. In the sleep mode, the OSC and all the EAs are turned off to reduce quiescent current. In the sleep mode, if any channel needs energy, the OSC is enabled, and the SIMO enters the PCC mode. In the PCC mode, if any channel enters to the EA mode, the SIMO enters the OPDC mode to sequentially provide energy to the EA-mode channel(s).

As described above, in one embodiment of the application, the oscillators and the EAs are turned off when the SIMO power converter is operated in PCC and PSM mode. Thus, in one embodiment of the application, the SIMO power converter has good efficiency at light load.

The application gains some of the limited space in the space-constrained electronic products back by using the single-inductor multiple-output (SIMO) power converter architecture. The SIMO architecture, along with the regulator's low quiescent current, enables to extend battery life for space-constrained electronic products.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A SIMO (Single Inductor Multiple Output) power converter including:
a power stage having an inductor and a plurality of switches coupled to the inductor, the power stage generating a plurality of output voltages from an input voltage;
a control circuit coupled to the power stage, the control circuit controlling the SIMO power converter to be operated at either an OPDC (Ordered Power Distributive Control) mode or a Peak Current Control (PCC) mode according with different loading conditions, the control circuit further generating a plurality of duty cycles based on an inductor current of the inductor and the plurality of output voltages; and
a logic control and gate driver, coupled to the control circuit and the power stage, the logic control and gate driver generating a plurality of switch control signals based on the duty cycles from the control circuit, the plurality of switch control signals for controlling the plurality of switches of the power stage.

2. The SIMO power converter according to claim 1, wherein in the OPDC mode, at least one channel of a plurality of channels needs energy for every clock cycle continuously; and wherein a plurality of energy distributing duty cycles are decided by a corresponding error amplifier (EA) output of the channel and the inductor current.

3. The SIMO power converter according to claim 2, wherein when the corresponding error amplifier (EA) output of the channel of the plurality of channels is lower than a predetermined voltage, the channel does not need energy for a next clock cycle and the channel enters a pulse skipping mode (PSM) mode.

4. The SIMO power converter according to claim 3, wherein when all the channels operate at the PSM mode or there are a predetermined successive cycles of zero inductor current signal detected, the SIMO power converter enters the PCC mode.

5. The SIMO power converter according to claim 4, wherein in the PCC mode, when no channel needs energy and the inductor current is discharged to zero, the SIMO power converter enters a sleep mode, in the sleep mode, an oscillator and a plurality of EAs of the SIMO power converter are all turned off; and
in the sleep mode, if any channel of the plurality of channels needs energy, the oscillator is enabled, and the SIMO power converter goes back to the PCC mode.

6. The SIMO power converter according to claim 4, wherein for all the channels in the PSM mode, when no channel needs energy continuously more than the predetermined number of clock cycles, the SIMO power converter keeps in the PCC mode.

7. The SIMO power converter according to claim 6, wherein for a channel in the PSM mode, the error amplifier of the channel is turned off; and the EA of the channel is turned on while the channel is going back to an EA mode, in the EA mode, the energy distributing duty cycle is response to the EA output.

8. The SIMO power converter according to claim 7, wherein an energy generating period under the PCC mode is decided by a specified inductor peak current or by a constant time period.

9. The SIMO power converter according to claim 7, wherein
if there is at least one channel operated at the EA mode, the SIMO power converter operates at the OPDC mode; and
an energy generating duty is in response of a sum of a plurality of control voltages, wherein the control voltage is the EA output at the EA mode and the control voltage is the predetermined voltage at the PSM mode.

10. A control method for a SIMO (Single Inductor Multiple Output) power converter generating a plurality of output voltages from an input voltage, the control method including:
controlling the SIMO power converter to be operated at either an OPDC (Ordered Power Distributive Control) mode or a Peak Current Control (PCC) mode according with different loading conditions;
generating a plurality of duty cycles based on an inductor current of an inductor and the plurality of output voltages; and
generating a plurality of switch control signals based on the duty cycles, the plurality of switch control signals for controlling a plurality of switches of the SIMO power converter.

11. The control method according to claim 10, wherein in the OPDC mode, at least one channel of a plurality of channels needs energy for every clock cycle continuously; and wherein a plurality of energy distributing duty cycles are decided by a corresponding error amplifier (EA) output of the channel and the inductor current.

12. The control method according to claim 11, wherein when the corresponding error amplifier (EA) output of the channel of the plurality of channels is lower than a predetermined voltage, the channel does not need energy for a next clock cycle and the channel enters a pulse skipping mode (PSM).

13. The control method according to claim 12, wherein when all the channels operate at the PSM mode or there are a predetermined successive cycles of zero inductor current signal detected, the SIMO power converter enters the PCC mode.

14. The control method according to claim 13, wherein in the PCC mode, when no channel needs energy and the inductor current is discharged to zero, the SIMO power converter enters a sleep mode.

15. The control method according to claim 14, wherein
in the sleep mode, an oscillator and a plurality of EAs of the SIMO power converter are all turned off; and
in the sleep mode, if any channel of the plurality of channels needs energy, the oscillator is enabled, and the SIMO power converter goes back to the PCC mode.

16. The control method according to claim 14, wherein for all the channels in the PSM mode, when no channel needs energy continuously more than the predetermined number of clock cycles, the SIMO power converter keeps in the PCC mode.

17. The control method according to claim 16, wherein for a channel in the PSM mode, the error amplifier of the channel is turned off; and the EA of the channel is turned on while the channel is going back to an EA mode, in the EA mode, the energy distributing duty cycle is response to the EA output.

18. The control method according to claim 17, wherein an energy generating period under the PCC mode is decided by a specified inductor peak current or by a constant time period.

19. The control method according to claim 17, wherein
if there is at least one channel operated at the EA mode, the SIMO power converter operates at the OPDC mode; and
an energy generating duty is in response of a sum of a plurality of control voltages, wherein the control voltage is the EA output at the EA mode and the control voltage is the predetermined voltage at the PSM mode.
